(19) United States
(12) Patent Application Publication
(10) Pub. No.: US 2008/0307071 A1
(43) Pub. Date: Dec. 11, 2008

(54) RETRIEVING SPECIFIC HIERARCHICAL INFORMATION USING WEB SERVICES

(75) Inventor: Venkata Naga Ravikiran Vedula, Bangalore (IN)

Correspondence Address: LAW FIRM OF NAREN THAPPETA, C/o Landon-IP Inc.,, 1700 Diagonal Road, Suite 450, Alexandria, VA, 22314, US

(73) Assignee: Oracle International Corporation, Redwood Shores, CA (US)

(21) Appl. No.: 11/779,923

(22) Filed: Jul. 19, 2007

(30) Foreign Application Priority Data
Jun. 5, 2007 (IN) 1155/CHE/2007

(51) Int. Cl. G06F 15/16

(52) U.S. Cl. 709/219

(57) ABSTRACT

Retrieving specific hierarchical information using web services. In one embodiment, a user sends a request containing an operation to be performed and a data indicating the specific information of interest to a web service. The web service determines the specific hierarchical information from a result of performance of the operation. The user then receives the determined information as a response to the request.

### RELATED APPLICATION

The present application is related to and claims priority from the co-pending India Patent Application entitled, “Retrieving Specific Hierarchical Information Using Web Services”, Serial Number: 1155/CHE/2007, attorney docket number: ORCL-054/India, Filed: Jun. 5, 2007 naming the same inventors as in the subject patent application, and is incorporated in its entirety herewith.

### BACKGROUND

1. Technical Field

The present disclosure relates to web technologies and more specifically to retrieving specific hierarchical information using web services.

2. Related Art

Web services are often employed to facilitate dissemination of information. A programmer implementing a web service defines operations that can be invoked from client systems, and invocation of each operation causes the corresponding program logic (provided/associated by the programmer) to be executed. The program logic often causes retrieval or generation of an information response, which is sent to the requesting client system.

Web services provide a flexible approach for programmers to define any desired number of operations (as opposed to specific key words only, in environments such as Structured Query Languages used with databases), with each operation being identified by a desired identifier. Each operation may also be provided with parameters, which are used by the program logic in processing the corresponding request.

Information included in the responses received from web service is often hierarchical. For example, the response data may be encoded in Extended Markup Language (XML), inherently defined to be hierarchical in nature. It is generally desirable that a user at a client system be provided control over the specific hierarchical information included in responses.

### BRIEF DESCRIPTION OF THE DRAWINGS

Example embodiments of the present invention will be described with reference to the accompanying drawings briefly described below.

FIG. 1 is a block diagram illustrating an example environment in which various aspects of the present invention can be implemented.

FIG. 2 is a flowchart illustrating the manner in which retrieval of specific hierarchical information using a web service is facilitated according to an aspect of the present invention.

FIG. 3A depicts a portion of data on which operations requested to a web service are performed in an embodiment.

FIG. 3B depicts a portion of a request containing an operation to be performed and data indicating the specific information to be retrieved sent to a web service in an embodiment.

FIG. 3C depicts a portion of a response containing specific hierarchical information requested from a web service in an embodiment.

FIG. 4 is a block diagram illustrating the details of an extended web service in an embodiment.

FIG. 5 depicts sample details of tags (and associated tag handlers) used for determining specific hierarchical information requested by a user in an embodiment.

FIG. 6 is a flowchart illustrating the manner in which a tag handler retrieves specific hierarchical information requested by a user using a web service in an embodiment.

FIG. 7 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

### 1. Overview

An aspect of the present invention facilitates retrieval of specific hierarchical information using web services. In one embodiment, a user sends a request containing an operation to be performed and a data indicating the specific information of interest to a web service. The web service performs the operation to generate a result, which is then used to determine the specific hierarchical information using the received data. The determined hierarchical information is then sent as a response to the user.

In an embodiment, the data indicating the specific hierarchical information is in the form of attributes, each attribute being associated with a name and a corresponding hierarchical expression indicating the location of the attribute in the result of performance of the requested operation.

As a result, only the specific hierarchical information of interest may be sent from a server implementing the web service to requesting client systems.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 2. Example Environment

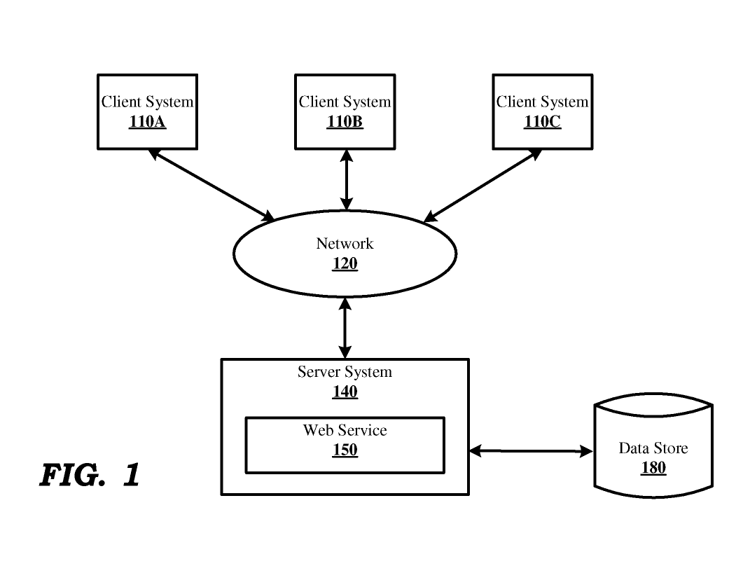

FIG. 1 is a block diagram illustrating an example environment in which various aspects of the present invention can be implemented. The block diagram is shown containing client systems 110A-110C, network 120, server system 140 (executing web service 150) and data store 180.

Merely for illustration, only representative number/type of systems is shown in the Figure. Many environments often contain many more systems, both in number and type, depending on the purpose for which the environment is designed. Each system/device of FIG. 1 is described below in further detail.

Network 120 provides connectivity between various client systems 110A-110C and server system 140. Network 120 may be implemented using protocols such as Internet Protocol (IP) well known in the relevant arts. Data store 180 facilitates storage and retrieval of a collection of data. In one embodiment, data store 180 is implemented using relational database technologies and therefore provides storage and retrieval of data using structured queries such as SQL.

Each of client systems 110A-110C represents a system such as a personal computer, workstation, mobile station, etc., and is used by a user to generate requests to server system 140 (and specifically to web service 150). The requests may be generated according to a suitable interface. In general, a client system requests the server system for performing operations (e.g., a transaction or retrieval of a desired content) and receives corresponding responses containing the information of interest generated from processing the request.

Server system 140 represents a system, such as a web server, which contains software (such as web service 150), which is capable of performing operations requested by client systems 110A-110C. The operations are defined by the developers of the software, as noted in the background section above. It may be appreciated that server system 140 may contain other software such as operating system, device drivers, etc., (not shown) that provide a run-time environment in which web service 150 is executed.

Web service 150 receives a request (from one of client systems 110A-110C) containing an operation to be performed and data indicating the specific information of interest. Web service 150 then determines and sends the specific information as a response to the requesting client system. The manner in which web service 150 facilitates retrieval of specific information is described below with examples.

### 3. Facilitating Retrieval of Specific Information

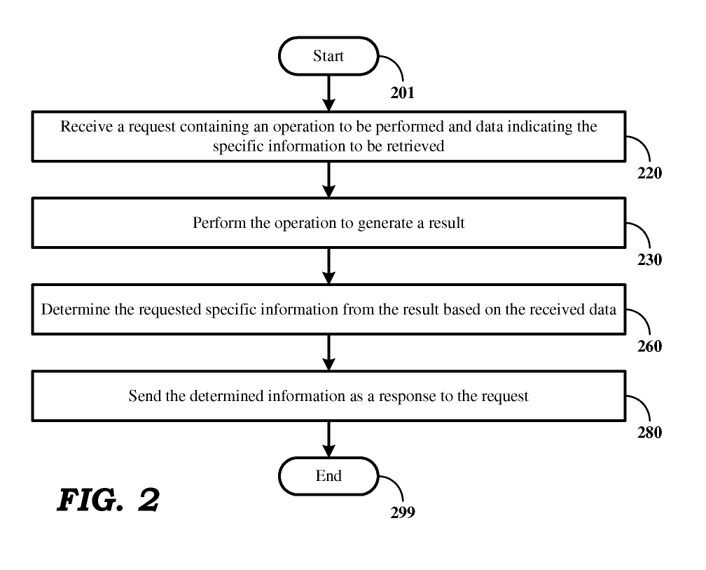

FIG. 2 is a flowchart illustrating the manner in which retrieval of specific hierarchical information using a web service is facilitated according to an aspect of the present invention. The flowchart is described with respect to FIG. 1 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 201, in which control immediately passes to step 220.

In step 220, web service 150 receives a request containing an operation to be performed and data indicating the specific information to be retrieved. The request may be received from one of client systems 110A-110C and may further contain values corresponding to the parameters of the operation. It may be appreciated that the requested operation may be one of a set of pre-defined operations (as defined by a programmer implementing the web service) and may be specified using a corresponding identifier.

In step 230, the operation is performed to generate a result. The operation can be performed external to web service 150 using an appropriate application or internally within web service 150 (for example, by a portion of web service 150). The result generally contains hierarchical information.

In step 260, web service 150 determines the requested specific information from the result based on the received data. The received data may indicate the hierarchical information (contained in the result) that needs to be included/excluded from the requested information. In one embodiment, the received data indicates the exact hierarchical information that is to be included in the requested information. Other information contained in the result are removed to generate the requested information or alternatively a new hierarchy (corresponding to the requested information) is generated.

In step 280, web service 150 sends the determined information as a response to the request. The response may be sent to the requesting system (one of client systems 110A-110C). It may be appreciated that the response also contains hierarchical information as necessitated by web services. The flow chart ends in step 299.

Thus, a user may retrieve specific hierarchical information using web services by sending a request containing an operation to be performed and data indicating the specific information to be retrieved to web service 150. The description is continued with an example illustrating the manner in which a user retrieves specific hierarchical information using web services in an embodiment.

### 4. Retrieving Specific Information

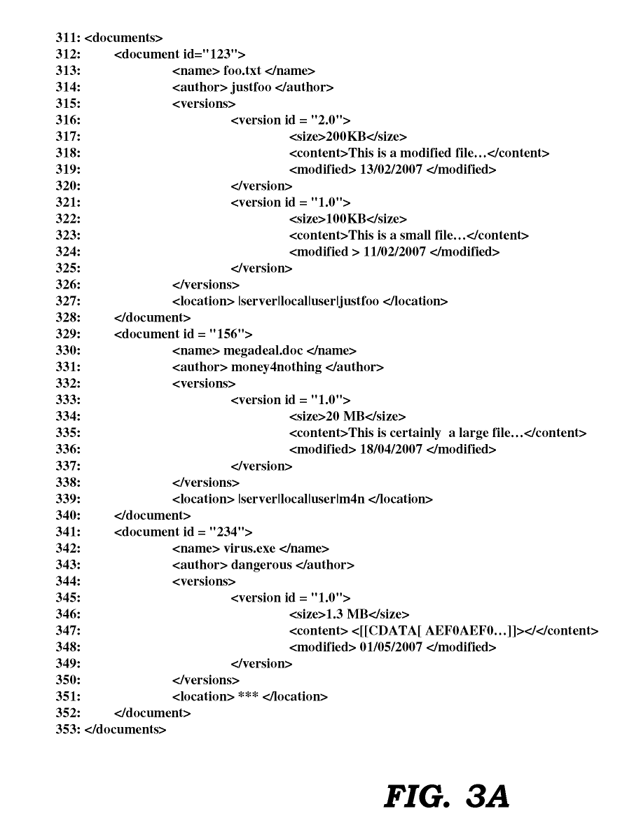

FIGS. 3A, 3B and 3C illustrate the manner in which specific hierarchical information is retrieved using web services in an embodiment. Each of the figures is explained in detail below.

FIG. 3A depicts a portion of data on which operations requested to a web service are performed in an embodiment. Though the content is shown encoded in extensible markup language (XML) according to one convention, other encoding/formats and conventions may be used for representing the data. It may be appreciated that the data may be retrieved from data store 180 (by sending a query to a database) or may be generated by an application executing in server system 140.

Lines 311-353 (between tags “<documents>” and “</documents>”) depict information associated with documents and may correspond to actual files stored on server system 140. The information may be maintained in real time by a file manager application (in data store 180) or may be generated as a result of performance of a previous operation requested from web service 150.

Lines 312-328 (between tags “<document>” and “</document>”) depict the information related to a single document/file identified by the value “123” (value of “id” in line 312). In particular, line 313 (between tags “<name>” and “</name>”) depicts the name “foo.txt” of the document; line 314 (between tags “<author>” and “</author>”) depicts the author “justfoo” of the document; lines 315-326 (between tags “<versions>” and “</versions>”) depicts the various versions of the document and line 327 (between tags “<location>” and “</location>”) depicts the physical location of the various versions of the document/file.

It may be observed that lines 315-326 depict the details of the various versions of the document. In particular, lines 316-320 depict the details of a version identified by the value “2.0” (value of “id” in line 316), having the size “200 KB” (between tags “<size>” and “</size>”) in line 317, having the content “This is a modified file . . . ” (between tags “<content>” and “</content>”) in line 318 and which was modified on “13/02/2007” (between tags “<modified>” and “</modified>”). Lines 321-325 depict the details of another version of the document identified by the value “1.0”.

Similarly, lines 329-340 and lines 341-352 depict the details of other documents/files stored on server system 140. Though the detail of the documents is depicted as being maintained/generated in a hierarchical manner, it may be appreciated that any suitable format may be used for such information.

A user may send requests (using one of client systems 110A-110C) for performance of an operation on the above-described information to web service 150. Along with the operation (and the associated parameters), the request may contain a set of attributes indicating the specific information to be retrieved. Each attribute may be associated with a name and a corresponding hierarchical expression indicating the location of the attribute in a result generated by performance of the operation. The manner in which a user may request an operation using a web service is described in detail below.

### 5. Sending Requests to a Web Service

FIG. 3B depicts a portion of a request containing an operation to be performed and data indicating the specific information to be retrieved sent to a web service in an embodiment. Though the request is shown encoded in simple object access protocol (SOAP) according to one convention, other encoding/formats and conventions may be used for encoding the request.

Line 361 (tag “<?xml?>”) indicates that the data in the request is encoded as XML. Lines 362-372 (between tags “<soap:Envelope>” and “</soap:Envelope>”) indicate that the request is encoded as a SOAP request, with the operation to be performed being specified between tags “<soap:Body>” and “</soap:Body>” (depicted in lines 363-371).

Lines 364-370 (between tags “<getDocument>” and “</getDocument>”) depict an operation (identified by the name “getDocument”) to be performed. Line 365 specifies a value “123” for a corresponding parameter “id” required for the performance of the operation “getDocument”. Thus, the operation specifies that the information corresponding to the document “123” be retrieved and sent as the response to the request.

Lines 366-369 (between tags “<requestedAttributes>” and “</requestedAttributes>”) depict a set of attributes indicating the specific information to be retrieved using the web service. In particular, line 367 (between tags “<attribute>” and “</attribute>”) depicts an attribute whose location is specified by the hierarchical expression “NAME” and associated with no name. Similarly line 368 depicts another attribute whose location is specified by the hierarchical expression “DOCUMENT:VERSIONS:VERSION[1]:CONTENT” and is associated with the name “RECENTDATA” (as specified by the word following the “as” keyword).

It may be observed that a hierarchical expression contains tags (such as “DOCUMENT”, “VERSIONS”, “CONTENT” etc.) separated by a pre-defined character “:”. The hierarchical expression is shown with sub-expressions such as “A:B” indicating the value of a “B” tag included in a “A” tag and “A[n]” indicating the “n” occurrence of a “A” tag. Thus, an expression such as “DOCUMENT:VERSIONS:VERSION[1]:CONTENT” indicates the value of a “CONTENT” tag contained in the first “VERSION” tag contained in a “VERSIONS” tag contained in a “DOCUMENT” tag. Though only a simple expression is shown in this example, it may be appreciated that the example may be extended to enable a user to specify more complex hierarchical expressions.

Web service 150 on receiving the above SOAP request performs the operation “getDocument” with the parameter “id” taking the value “123” as specified in the request. It may be appreciated that an application performing the operation may generate a result containing all the details (as depicted in lines 312-328) of the document identified by “123” including the content of the various versions of the document.

In a prior approach, the result of performance of the operation may be sent as the response to the requesting client system. As such, a larger amount of information not required by the user may be sent thereby potentially affecting the behavior of network 120.

In another prior approach, only the identifiers of the different versions of the documents may be included in the response. A user desiring a specific version may be required to send a second request containing a second operation (for example, “getVersion”) with the identifier of the specific version desired. Such an approach may not be desirable in scenarios where the information is represented as a hierarchy with a large number of levels (thereby requiring a user to send an equivalent number of requests).

An aspect of the present invention extends a web service to enable a user to include in the request, a set of attributes indicating the specific information to be retrieved. In the above request, the set of attributes specified in lines 366-369 indicate the specific information to be retrieved. Web service 150 determines the specific information indicated by the set of attributes and sends the determined information as the response to the request as described in detail below.

### 6. Receiving Responses from a Web Service

FIG. 3C depicts a portion of a response containing specific hierarchical information requested from a web service in an embodiment. Though the response is shown encoded in simple object access protocol (SOAP) according to one convention, other encoding/formats and conventions may be used for encoding the response.

Line 381 (tag “<?xml?>”) indicates that the data in the request is encoded as XML. Lines 382-391 (between tags “<soap:Envelope>” and “</soap:Envelope>”) indicate that the request is encoded as a SOAP request, with the result of the requested operation specified between tags “<soap:Body>” and “</soap:Body>” (depicted in lines 383-390).

Lines 384-389 (between tags “<getDocumentResponse>” and “</getDocumentResponse>”) depict the result of performance of a request. It may be appreciated that the information in lines 384-389 may be received in response to the request depicted in FIG. 3B (with the requested operation “getDocument” having been performed on the data depicted in FIG. 3A).

Lines 385-388 (between tags “<attributes>” and “</attributes>”) depict the specific hierarchical information included in the response corresponding to the set of attributes requested (depicted in lines 366-369).

Thus, in line 386 (between tags “<attribute>” and “</attribute>”) the value “foo.txt” associated with the name “NAME” is generated corresponding to line 367 in the request, which indicates that the name of the document (as specified by the hierarchical expression “NAME”) be included in the response. Since no attribute name is specified in the request, a default attribute name corresponding to the tag identified by the hierarchical expression is used instead.

Similarly, in line 387, the value “This is a modified file . . . ” associated with the name “RECENTDATA” is generated corresponding to line 368 in the request, which indicates that the content (“CONTENT”) of the first version (“VERSIONS:VERSION[1]”) of the document (“DOCUMENT”) be included in the response associated with the attribute name “RECENTDATA”.

It may be observed that only the specific information (as indicated by the set of attributes in the request) is included in the response. Thus, a user is provided more control over the specific hierarchical information included in the responses. The description is continued describing the manner in which a web service is extended to enable users to retrieve specific hierarchical information using the web service in an embodiment.

### 7. Extending a Web Service

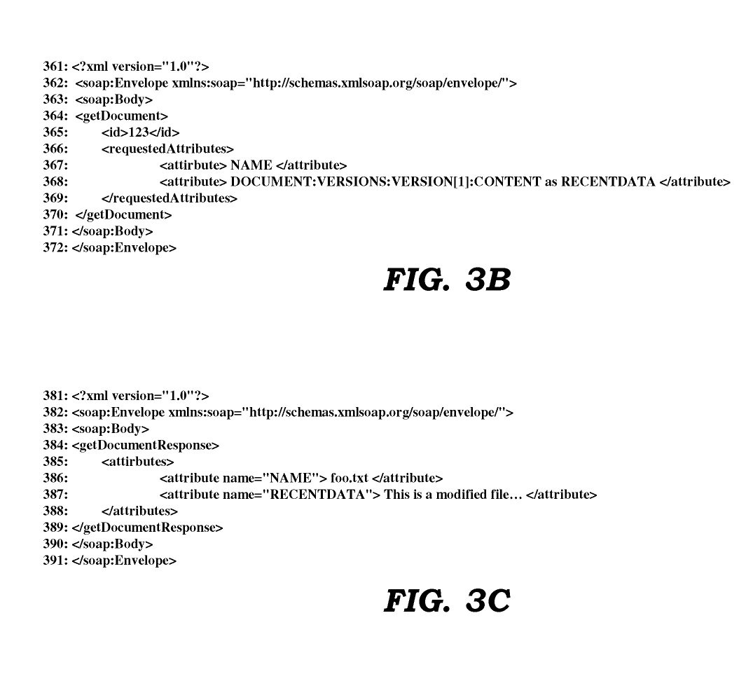

FIG. 4 is a block diagram illustrating the details of web service 150 in an embodiment. The block diagram is shown with request manager 420, information handler 450 and application 480. Each block is described below.

Request manager 420 receives requests (for example, the request depicted in FIG. 3A) for operations from a user using one of client systems 110A-110C (via communication path 422). On receiving a request, request manager 420 may inspect/decode the request to determine the operation to be performed. Request manager 420 may then send the operation along with the associated parameter values to application 480.

Request manager 420, on receiving a result of performance of the operation from application 480, determines whether the request contains data (a set of attributes) indicating specific information to be retrieved. In the scenario that the request does not contain any data indicating specific information, request manager 420 sends the result received from application 480 as the response to the requested operation.

In the scenario where the request contains data indicating specific information, request manager 420 sends the result received from application 480 and the data (i.e., set of attributes) to information handler 450. Request manger 420 then receives the specific information from information handler 450 and sends the specific information as the response to the received request.

Application 480 represents a set of software instructions that contains the program logic associated with an operation requested of web service 150. Application 480 receives from request manager 420, an operation to be performed and associated parameter values. Application 480 performs the operation using the parameter values and generates a result (may be using data retrieved from data store 180 via communication path 488). The result is sent to request manger 420.

Information handler 450 receives the result of performance of an operation and data indicating the specific information to be retrieved from request manager 420. Information handler 450 then determines the specific information from the result based on the received data. The specific information determined is then sent to request manager 420.

Though information handler 450 and application 480 are depicted as being internal to web service 150, it may be appreciated that in alternative embodiments, web service 150 (containing request manager 420), information handler 450 and application 480 may be implemented as independent applications executing in the run-time environment of server system 140.

It may be further appreciated that request manager 420 and application 480 together represent a web service 150 (without extensions). In such a scenario, request manager 420 receives requests for operations, performs the operations using application 480 and sends the results of performance of the operations as the responses corresponding to the requests.

By incorporating information handler 450, web service 150 is extended to accept requests that indicate the specific information to be retrieved and to send corresponding responses containing only the specific information. The manner in which information handler 450 determines the specific information requested by a user is illustrated below with examples.

### 8. Determining Specific Information

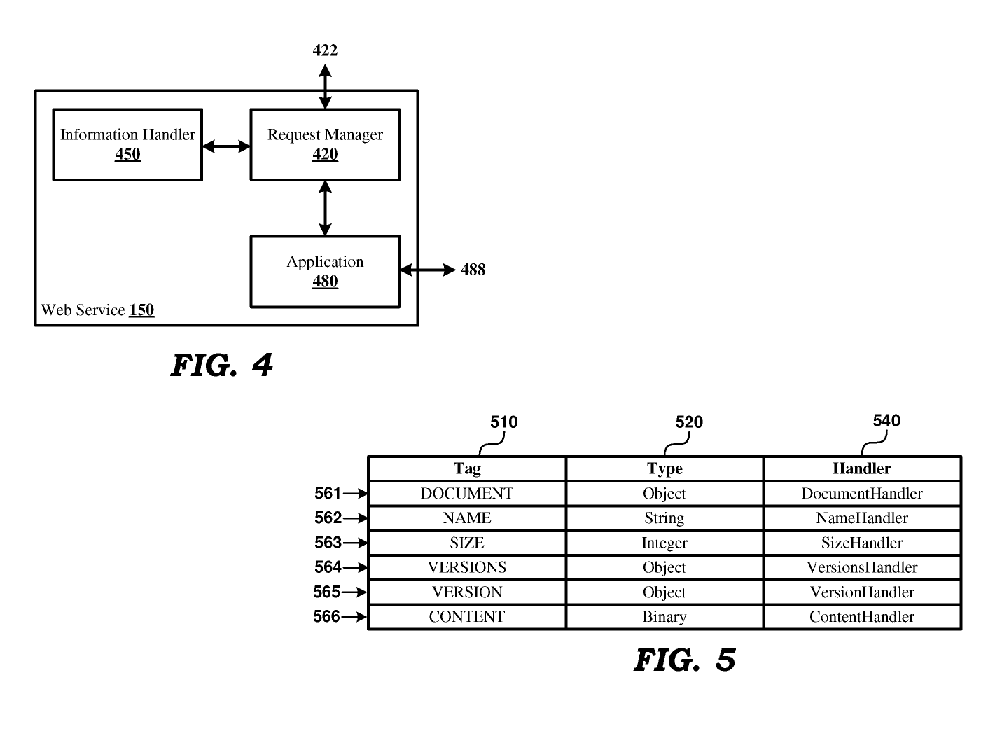

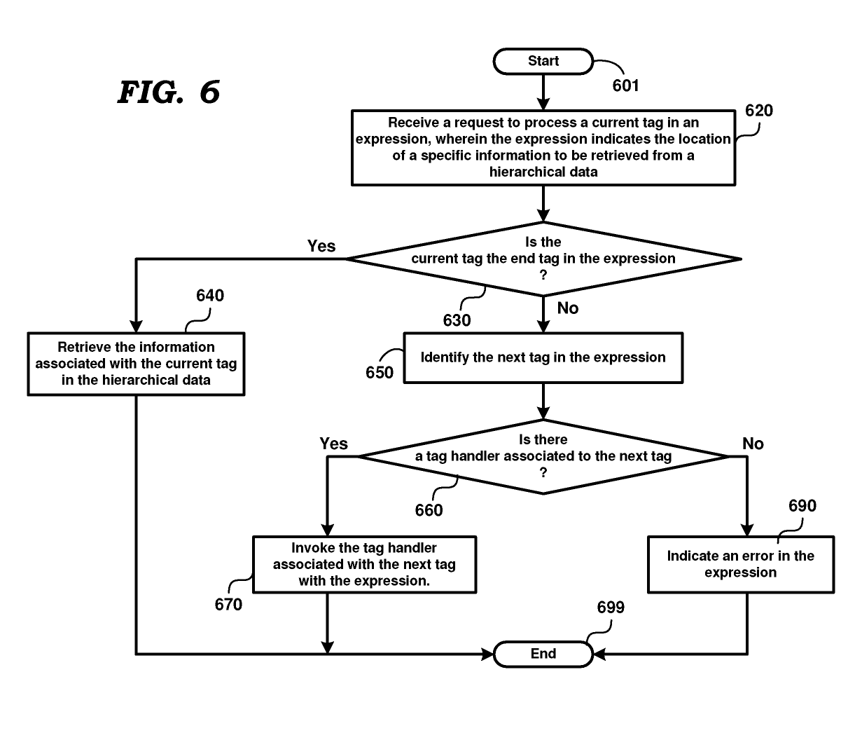

FIGS. 5 and 6 illustrate the manner in which an information handler determines the specific hierarchical information requested by a user in an embodiment. Each of the figures is explained in detail below.

As explained above, hierarchical expressions (containing tags separated by the character “:”) may be used to indicate the location of the specific information in a result of performance of an operation. In one embodiment, each of the tags contained in the hierarchical expressions is associated with a corresponding software code (called tag handler), which is invoked when the associated tag is contained in a hierarchical expression. Information handler 450 may maintain information (in data store 180) about the tags and the associated tag handlers as described below with examples.

FIG. 5 depicts sample details of tags (and associated tag handlers) used for determining specific hierarchical information requested by a user in an embodiment. Though the sample detail is depicted as being stored in a table in a database, in alternative embodiments, the details may be stored in any convenient format/storage medium.

Column 510 (labeled “Tag”) indicates the name of each tag. Column 520 (labeled “Type”) specifies the type of each tag. The type of each tag indicates the expressions that may be used on the tag. For example, the type “Object” associated with a tag indicates that the tag contains other tags and the hierarchical expression may be extended further using the character “:”. Column 540 (labeled “Handler”) specifies the name of the tag handler associated with each tag. It may be appreciated that the software code constituting the tag handlers may be provided in any convenient/pre-defined format (such as a Java™ package containing classes corresponding to each of the tag handlers).

Row 561 specifies a tag “DOCUMENT” (as specified by the name in column 510) which contains other tags (as specified by the type “Object” in column 520) and associated with a tag handler named “DocumentHandler” (as specified in column 540). Thus, when a hierarchical expression is received that contains the tag “DOCUMENT”, the associated tag handler named “DocumentHandler” is invoked. Similarly, rows 562-566 specify the details of other tags that may be contained in hierarchical expressions.

Information handler 450 on receiving a set of attributes determines for each attribute, the specific information identified by the corresponding hierarchical expression associated with the attribute. For processing a hierarchical expression, information handler 450 first determines the first tag in the expression and invokes a tag handler associated with the first tag. The tag handler may then invoke another tag handler corresponding to the next tag in the hierarchical expression. Thus, a chain of tag handlers is invoked until the specified information is retrieved by the end tag handler corresponding to the end tag of the hierarchical expression.

Thus, information handler 450 on receiving a set of attributes (depicted in lines 366-369) and a hierarchical data (depicted in lines 312-328 corresponding to the result of performance of the operation specified in the request depicted in FIG. 3B) determines the specific information identified by the hierarchical expression associated with each of the attributes. For example, information handler 450 to determine the specific information corresponding to the attribute “RECENTDATA” processes the associated hierarchical expression “DOCUMENT:VERSIONS:VERSION[1]:CONTENT”.

As such, information handler 450 identifies the first tag “DOCUMENT” in the hierarchical expression and will invoke the corresponding tag handler named “DocumentHandler” (as indicated by row 561). The “DocumentHandler” then invokes “VersionsHandler” (as indicated by row 564), which in turn invokes “VersionHandler” (as indicated by row 565) with the sub-expression “[1]”, which then invokes “ContentHandler” (as indicated by row 566). The “ContentHandler” on determining that “CONTENT” is the end tag, returns the specific information corresponding to the hierarchical expression to information handler 450.

The description is continued describing the manner in which specific information requested by a user is retrieved by a tag handler in an embodiment.

### 9. Tag Handlers

FIG. 6 is a flowchart illustrating the manner in which a tag handler retrieves specific hierarchical information requested by a user using a web service in an embodiment. The flowchart is described with respect to FIG. 4 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 601, in which control immediately passes to step 620.

In step 620, a tag handler receives a request to process a current tag in an expression, wherein the expression indicates the location of the specific information to be retrieved from a hierarchical data. The request may be received from information handler 450 or another tag handler (associated to the tag occurring previous to the current tag in the expression). It may be appreciated that along with the expression, the request may contain other information such as sub-expression of the current tag specified in the expression and the information associated with the current tag in the hierarchical data.

In step 630, the tag handler checks whether the current tag is the end tag in the expression. The current tag may be determined to be an end tag in the scenario that the received expression ends with the name of the current tag. Control passes to step 640 in the scenario that the current tag is the end tag and to step 650 otherwise.

In step 640, the tag handler retrieves the information associated with the current tag in the hierarchical data. The information associated with the current tag may be received from a previous tag handler or information handler 450. Alternatively, the tag handler may determine the information by traversing the hierarchical data based on the received expression. The retrieved information corresponds to the specific hierarchical information requested by a user. Control passes to step 699.

In step 650, the tag handler identifies the next tag in the expression. The name of the tag occurring after the character “:” following the name of the current tag may be determined and identified as the next tag in the expression. During the identification of the next tag, any sub-expression associated with the next tag may also be determined.

In step 660, the tag handler checks the existence of a tag handler associated to the next tag. The determination may be performed by inspecting data that contains tags (and the associated tag handlers) occurring in hierarchical expressions (for example, the data depicted in FIG. 5). Control passes to step 670 in the scenario that a tag handler associated to the next tag exists and to step 690 otherwise.

In step 670, the tag handler invokes the tag handler associated with the next tag with the expression. As described above, the tag handler when invoking the next handler may send a request containing the expression and other information such as a sub-expression of the next tag determined to be in the expression in step 650 and the information associated with the next tag in the hierarchical data. It may be appreciated that the next tag becomes the current tag during the execution of the next tag handler. Control passes to step 699.

In step 690, the tag handler indicates an error in the expression. The error may indicate that a tag (i.e., the next tag) included in the expression does not exist or such a tag is incorrectly positioned in the expression. It may be appreciated that the tag handler may indicate other errors (such as applying functions to wrong types or inaccurate sub-expressions) during the performance of the above steps. The flow chart ends in step 699.

Continuing the above example, information handler 450 to process a hierarchical expression such as “DOCUMENT:VERSIONS:VERSION[1]:CONTENT” will firstly invoke the tag handler named “DocumentHandler”.

In the “DocumentHandler”, the above expression and the hierarchical data (depicted in lines 312-328) are received in step 620 with the current tag set as “DOCUMENT”. In step 630, the “DocumentHandler” determines that the current tag is not the end tag and control passes to step 650. In step 650, the next tag “VERSIONS” is identified (the tag name occurring after the “:” following name “DOCUMENT” of the current tag) and in step 660, control passes to step 670 since there exists a tag handler “VersionsHandler” associated with the next tag “VERSIONS”. In step 670, the “VersionsHandler” is invoked with the expression, the hierarchical data and a data indicating the location of the next tag in the hierarchical data (for example, a pointer to line 315).

In the “VersionsHandler”, the above expression, the hierarchical data and a pointer to line 315 are received in step 620 with the current tag set as “VERSIONS”. In step 630, the “VersionsHandler” determines that the current tag is not the end tag and control passes to step 650. In step 650, the next tag “VERSION” and the associated sub-expression “[1]” is identified and in step 660, control passes to step 670 since there exists a tag handler “VersionHandler” associated with the next tag “VERSION”. In step 670, the “VersionHandler” is invoked with the expression, the hierarchical data, the sub-expression “[1]” and a pointer to line 316.

Similarly in the “VersionHandler”, in step 670, the next tag handler “ContentHandler” is invoked with the expression, the hierarchical data and a pointer to line 318. In the “ContentHandler”, in step 630, the current tag “CONTENT” is determined to be the end tag since the expression ends with the name of the current tag. As such, control passes to step 640, where the information “This is a modified file . . . ” associated with the current tag (as indicated the pointer to line 318) in the hierarchical data is retrieved. The retrieved information is then sent to information handler 450 as the specific hierarchical information requested by a user.

It should further be appreciated that the features of web service 150 may be implemented in a combination of one or more of hardware, software and firmware. The description is continued with respect to an embodiment in which various features are operative by execution of corresponding software instructions.

### 10. Digital Processing System

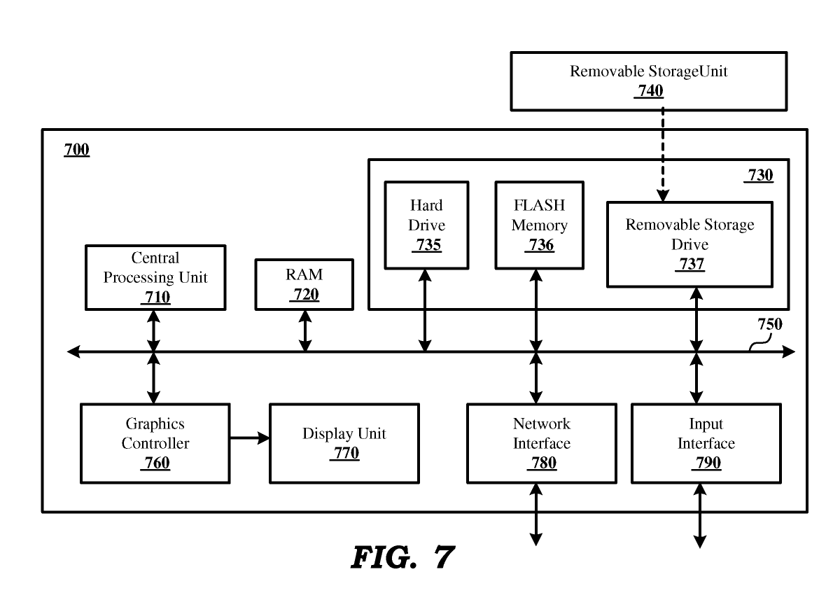

FIG. 7 is a block diagram illustrating the details of digital processing system 700 in which various aspects of the present invention are operative by execution of appropriate software instructions. Digital processing system 700 may correspond to server system 140 (executing web service 150).

Digital processing system 700 may contain one or more processors (such as a central processing unit (CPU) 710), random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present invention. CPU 710 may contain multiple processing units, with each processing unit potentially being designed for a specific task. Alternatively, CPU 710 may contain only a single general-purpose processing unit. RAM 720 may receive instructions from secondary memory 730 using communication path 750.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse). Network interface 780 provides connectivity to a network (e.g., using Internet Protocol), and may be used to communicate with other connected systems (such as client systems 110A-110C) of FIG. 1.

Secondary memory 730 may contain hard drive 735, flash memory 736, and removable storage drive 737. Secondary memory 730 may store the data (e.g., portions of data depicted in FIGS. 3A and 5) and software instructions, which enable digital processing system 700 to provide several features in accordance with the present invention. Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable storage medium having stored therein computer software and/or data. However, the computer (or machine, in general) readable storage medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present invention described above.

### 11. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method of facilitating retrieval of specific information from a web service, said method being performed in a server, said method comprising:
receiving a request containing an operation to be performed and a data indicating said specific information to be retrieved;
performing said operation to generate a result;
determining said specific information from said result based on said data; and
sending said specific information as a response to said request.

2. The method of claim 1, wherein said data contains a set of attributes, wherein each attribute is associated with a name and a hierarchical expression indicating a location of a value associated with the attribute in said result, wherein said determining further comprises:
processing each of said hierarchical expressions corresponding to said set of attributes to identify a corresponding value; and
including each of said names of said set of attributes and corresponding identified value in said specific information.

3. The method of claim 2, wherein said result is according to extended markup language (XML), and said location identifies a tag according to XML.

4. The method of claim 3, wherein a first hierarchical expression associated with a first attribute indicates a location of a first value, wherein said first hierarchical expression further contains a sequence of tags, wherein said processing further comprises:
identifying a first tag in said sequence of tags;
invoking a first tag handler to process said first tag, wherein said first tag handler is designed to handle only said first tag; and
receiving said first value from an end tag handler designed to handle an end tag in said sequence of tags, wherein each tag handler is designed to invoke a next tag handler designed to handle the next tag in said sequence of tags.

5. The method of claim 4, wherein said first tag handler is operable to:
receive said first tag and said hierarchical expression containing said sequence of tags;
determine whether said first tag is the end tag in said sequence of tags,
retrieve a data from said result at the location indicated by said hierarchical expression if said first tag is the end tag, wherein said data is returned as said first value.

6. The method of claim 5, wherein said first tag handler is further operable to:
identify a next tag in said sequence of tags, wherein said next tag occurs after said first tag;
invoke said next tag handler associated with said next tag.

7. The method of claim 1, wherein said request and said response is encoded in simple object access protocol (SOAP).

8. A method of retrieving specific information using a web service, said method comprising:
sending a request to said web service, wherein said request contains an operation to be performed and a data indicating said specific information to be retrieved, wherein said operation is one of a plurality of operations provided by a designer implementing said web service, wherein performance of said operation is designed to generate a result; and
receiving a response to said request, wherein said response contains said specific information determined from said result.

9. A computing system comprising:
a request manager for receiving a web service request containing an operation to be performed and a data indicating a specific information to be retrieved;
an application designed to provide a result of performance of said operation, wherein said result contains said specific information; and
an information handler for determining said specific information from said result based on said data,
wherein said request manager sends a web service response containing said specific information.

10. The computing system of claim 1, wherein said data contains a set of attributes, wherein each attribute is associated with a name and a hierarchical expression indicating a location of a value associated with the attribute in said result, wherein said information handler is further operable to:
process each of said hierarchical expressions corresponding to said set of attributes to identify a corresponding value; and
include each of said names of said set of attributes and corresponding identified value in said specific information.

11. The computing system of claim 10, wherein said result is according to extended markup language (XML), and said location identifies a tag according to XML.

12. The computing system of claim 11, wherein a first hierarchical expression associated with a first attribute indicates a location of a first value, wherein said first hierarchical expression further contains a sequence of tags, wherein said information handler is further operable to identify a first tag in said sequence of tags, said computing system further comprising:
a first tag handler invoked by said information handler, wherein said first tag handler is designed to handle only said first tag; and
an end tag handler designed to handle an end tag in said sequence of tags, wherein each tag handler is designed to invoke a next tag handler designed to handle the next tag in said sequence of tags,
wherein said information handler receives said first value from said end tag handler.

13. The computing system of claim 13, wherein said first tag handler is further operable to:
receive said first tag and said hierarchical expression containing said sequence of tags;
determine whether said first tag is the end tag in said sequence of tags; and
retrieve a data from said result at the location indicated by said hierarchical expression if said first tag is the end tag, wherein said data is returned as said first value.

14. The method of claim 13, wherein said first tag handler is further operable to:
identify a next tag in said sequence of tags, wherein said next tag occurs after said first tag; and
invoke said next tag handler associated with said next tag.

15. A machine readable medium storing one or more sequences of instructions for causing a server system to facilitate retrieval of specific information from a web service, wherein execution of said one or more sequences of instructions by one or more processors contained in said server system causes said server system to perform the actions of:
receiving a request containing an operation to be performed and a data indicating said specific information to be retrieved;
performing said operation to generate a result;
determining said specific information from said result based on said data; and
sending said specific information as a response to said request.

16. The machine readable medium of claim 15, wherein said data contains a set of attributes, wherein each attribute is associated with a name and a hierarchical expression indicating a location of a value associated with the attribute in said result, wherein said determining further comprises:
processing each of said hierarchical expressions corresponding to said set of attributes to identify a corresponding value; and
including each of said names of said set of attributes and corresponding identified value in said specific information.

17. The machine readable medium of claim 16, wherein a first hierarchical expression associated with a first attribute indicates a location of a first value, wherein said first hierarchical expression further contains a sequence of tags, wherein said processing further comprises:
identifying a first tag in said sequence of tags;
invoking a first tag handler to process said first tag, wherein said first tag handler is designed to handle only said first tag; and
receiving said first value from an end tag handler designed to handle an end tag in said sequence of tags, wherein each tag handler is designed to invoke a next tag handler designed to handle the next tag in said sequence of tags.

18. The machine readable medium of claim 17, wherein said first tag handler is operable to:
receive said first tag and said hierarchical expression containing said sequence of tags;
determine whether said first tag is the end tag in said sequence of tags; and
retrieve a data from said result at the location indicated by said hierarchical expression if said first tag is the end tag, wherein said data is returned as said first value.

19. The machine readable medium of claim 18, wherein said first tag handler is further operable to:
identify a next tag in said sequence of tags, wherein said next tag occurs after said first tag; and
invoke said next tag handler associated with said next tag.

20. The machine readable medium of claim 19, wherein said request and said response is encoded in simple object access protocol (SOAP).
